(19) United States
(12) Patent Application Publication
(10) Pub. No.: US 2023/0261409 A1
(43) Pub. Date: Aug. 17, 2023

(54) Safety electrical outlet

(71) Applicant: Nuculus AS, Trondheim (NO)

(72) Inventors: Roland Johansson, Vittsjö (SE); Mikael Liljegren, Tingstäde (SE); Fredrik Lennartsson, Henån (SE); Arve Saetran, Trondheim (NO)

(21) Appl. No.: 17/782,795

(22) PCT Filed: Dec. 4, 2020
(86) PCT No.: PCT/IB2020/061494

§ 371 Date: Jun. 6, 2022

(30) Foreign Application Priority Data
Dec. 6, 2019 (SE) 1930392-4

(51) Int. Cl. H01R 13/453

(52) U.S. Cl. CPC H01R 13/4532

(57) ABSTRACT

There is disclosed a safety electrical outlet including a female outlet that when in use receives a male part of an electrical plug therein to establish electrical connection therebetween, a protective plate configured to cover the female outlet in a first position, and locking means, coupled to the protective plate, configured to maintain the protective plate in the first position when in a locked state. The locking means includes a retractable element maintaining the protective plate in the first position. Specifically, the retractable element retracts to allow the locking means to release the protective plate when pressed by the male part of the electrical plug. Further, the retractable element is a disc, having holes arranged to communicate with the plurality of holes in the protective plate and in the female outlet.

### TECHNICAL FIELD

The present disclosure relates generally to electrical outlets; and more specifically, to safety electrical outlets comprising locking means.

### BACKGROUND

Since the development of the first electric switch, development in the designs and functionalities of such electrical plugs and outlets has had a dramatic change. A proliferation of types of electrical plugs and outlets have been developed to address the issues of convenience and protection from electric shock. Today, there are approximately twenty types of electrical plugs and outlets in common use around the world. As countries seek to address future energy requirements in a rapidly growing and changing world, using electricity as a means of achieving sustainable transportation has emerged as a vital mission. Electric vehicles (EVs) represent one of the most promising pathways to increased energy security and reduced emissions of greenhouse gases and other pollutants. EVs reduce dependence on petroleum products and tap into a source of electricity that is often domestic and relatively inexpensive.

Generally, electrical plugs and outlets are known to have short life spans due to several reasons generating a frequent replacement need. Reasons include accidental damage and external environmental factors such as humidity and temperature that can lead to damaged plugs and outlets likely to become a dust trap and, ultimately, a fire hazard lint, dust and hair act as kindling when they accumulate, making electrical outlets prime accumulation spots. In addition to accidental fires, under the right conditions dust can straight up cause explosions. Another problem that persists is the safety and security of the users while employing said switches. Currently, existing switches are not tamperproof which makes them susceptible to unintended usage. This presents a security flaw for users, especially children who tend to stick external objects at unusual places and risk electrocution.

One of the challenges in providing a reliable solution to aforementioned problems are the numerous differing standards used in the male part of electrical plugs and female outlets that are coming to market, since their various outlets and plugs have different capacities. Existing solutions to overcome the existing problems provide expensive impractical solutions which requires the male parts of the electrical plug to be adapted in accordance to a change in the female outlet configurations. Notably, replacement of both the male plug and female outlets renders this replacement operation for companies and communities too expensive to implement.

Therefore, in light of the foregoing discussion, there exist problems associated with conventional safety electrical outlets.

### SUMMARY

The present disclosure seeks to provide a safety electrical outlet. The present disclosure also seeks to provide a means to prevent unauthorised access to a female outlet. The present disclosure seeks to provide a solution to the existing problem of damage of electrical outlets via external influences. An aim of the present disclosure is to provide a solution that overcomes at least partially the problems encountered in prior art, and provides a tamperproof electrical outlet.

In one aspect, an embodiment of the present disclosure provides a safety electrical outlet comprising:
a female outlet that when in use receives a male part of an electrical plug therein to establish electrical connection therebetween;
a protective plate configured to cover the female outlet in a first position, wherein the protective plate is rotated from the first position to a second position for uncovering the female outlet when released by a locking means, wherein the protective plate includes a plurality of holes corresponding to receptacles of the female outlet, wherein the plurality of holes aligns with the receptacles of the female outlet when the protective plate is in the second position; and
the locking means, coupled to the protective plate, configured to maintain the protective plate in the first position when in a locked state, wherein the locking means releases the protective plate upon receiving the male part of the electrical plug, the locking means comprising:
   a retractable element maintaining the protective plate in the first position, wherein the retractable element retracts to allow the locking means to release the protective plate when pressed by the male part of the electrical plug,
   wherein the retractable element is a disc, having holes arranged to communicate with the plurality of holes in the protective plate and in the female outlet,
   wherein the disc is:
   arranged between the female outlet and the protective plate;
   rotationally locked to the female outlet;
   tiltable supported on the female outlet; and
   axially spring biased towards the protective plate,
      wherein the protective plate is spring biased towards its first position.

Embodiments of the present disclosure substantially eliminate or at least partially address the aforementioned problems in the prior art, and provides a reliable, secure, and shock-proof electrical outlet.

In another aspect, an embodiment of the present disclosure provides a safety electrical outlet comprising a female outlet that when in use receives a male part of an electrical plug therein to establish electrical connection therebetween, a protective plate configured to cover the female outlet in a first position, wherein the protective plate is rotated from the first position to a second position for uncovering the female outlet when released by a locking means, wherein the protective plate includes a plurality of holes corresponding to receptacles of the female outlet, wherein the plurality of holes aligns with the receptacles of the female outlet when the protective plate is in the second position. Furthermore, the safety electrical outlet comprises the locking means, coupled to the protective plate, configured to maintain the protective plate in the first position when in a locked state, wherein the locking means releases the protective plate upon receiving the male part of the electrical plug, the locking means comprising a retractable element for maintaining the protective plate in a first position, wherein the retractable element retracts to allow the locking means to release the protective plate when pressed by a male part of an electrical plug, wherein the retractable element is at least one of: a spring-loaded U-shaped rod, a pair of resilient fingers, a button on the female outlet.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is an exploded view of a safety electrical outlet having the locking means implemented as a disc, in accordance with an embodiment of the present disclosure;

FIG. 2 is an underside view of the disc, in accordance with an embodiment of the present disclosure.

FIG. 3 is a schematic illustration of a perspective view of the female outlet having the plug lock at the outer boundary, in accordance with an embodiment of the present disclosure;

FIGS. 4A and 4B are sectional views of a locking means, in accordance with a second implementation of the present disclosure;

FIGS. 5A and 5B are perspective views of a locking means, in accordance with a third implementation of the present disclosure;

FIGS. 6A and 6B are perspective views of a locking means, in accordance with a fourth implementation of the present disclosure; and

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

The present disclosure provides a safety electrical outlet. Furthermore, the safety electrical outlet includes a protective plate to ensure protection of the female outlet from external environment and accidental damage, when not in use. The safety electrical outlet also comprises a protective plate configured to cover the female outlet in a first position. Furthermore, the locking means, coupled to the protective plate is configured to maintain the protective plate in a first position when in locked state, and releases the protective plate upon receiving the male part of the electrical plug. Moreover, the protective plate includes a plurality of holes corresponding to receptacles of the female outlet and the plurality of holes aligns with the receptacles of the female outlet when the protective plate is in the second position. The design of the locking means described in the present disclosure is intuitive to a user and does not require complex mechanisms for unlocking. Furthermore, the safety electrical outlet is compatible with any existing electrical plugs and does not require specific customisation of the electrical plugs. The locking means of the present disclosure locks the protective plate in a manner that the female outlet is reliably protected from factors in the external environment such as dust, water and humidity exposure, prevents accidental damage and also restricts unintended use (such as, by children). Notably, the protective plate is configured such that the engagement and disengagement cannot be altered or hampered externally through any means apart from insertion of the earth pin and/or rotation of the electrical plug. Furthermore, the safety electrical outlet does not provide any information thereon referring to unlocking of the locking means to release the protective plate, thereby making it difficult for an unintended user (such as, a child) to access the female outlet.

The safety electrical outlet may also comprise a plug lock configured to ensure reliable coupling of the electrical plug to the female outlet, when in use.

Throughout the present disclosure the term “safety electrical outlet” refers to an electrical socket having secure covering and/or protection means to prevent accidental damage, reduce exposure of the electrical connections to external environment and limit unintended use. Furthermore, herein the electrical socket refers to a female outlet that accepts male connectors of electrical plugs therein to establish electrical connectivity between the electrical outlet and the electrical plug. Moreover, the electrical outlets include receptacles in the female outlet to receive pins from electrical plugs to build an electrical connection therebetween. Generally, the receptacles of the electrical outlets are made up of electrically conducting materials such as copper, aluminium, and gold and silvers. In an example, the safety electrical outlets may be provided or fixed at walls, floors, ceilings and the like. In an example, the electrical outlets may be arranged at public vehicle charging stations, rooms of a building, machine equipment such as battery chargers, and the like. In general, the electrical outlets are available in two pins, three pins, five pins, and the like. Traditionally, the electrical outlets include ends having a circular surface, curved triangular surfaces, curved square surfaces, and the like.

The safety electrical outlet comprises a female outlet that when in use receives a male part of an electrical plug therein to establish electrical connection therebetween. It will be appreciated that the term “female outlet” used herein refers to an electrical socket with receptacles to receive male parts of an electrical plug therein to establish electrical conductivity therebetween. Furthermore, the receptacles of the female outlets may include metallic strips that when in use connect to the metallic pins of the electrical plug and conduct electricity between the electrical plug and the female outlet. In an instance, the female outlets may include two receptacles, three receptacles, five receptacles, and the like based on purpose and requirements. In an example, the receptacles of the female outlet may include metallic strips made up of copper, aluminium and the like. The female outlet typically has a housing which may have a plug lock socket to enable an inserted electrical plug to be retained. The female outlet may have a cover plate with orifices to provide access for the male parts to the receptacles. The cover plate may be made of an insulating material to protect the receptacles from unintentional direct contact between a receptacle and the wrong male part for that receptacle. The receptacles may be mounted in connector block inserted into the female outlet, optionally from behind, i.e. the opposite direction from which the male parts are inserted.

Optionally, the safety electrical outlet comprises a plug lock configured to secure the electrical plug to the female outlet, when in use. The term “plug lock” used herein relates to a locking arrangement provided at an engagement of the female outlet and the electrical plug to restrict movement or unintended removal of the electrical plug from the electrical outlet. In an instance, when the electrical connection is established by the coupling of the female outlet and the electrical plug, a slight movement may disconnect the electrical connection. Therefore, the movement is restricted when the electrical connection is established. Furthermore, the plug lock also ensures a safety from external influences such as sudden shake, fluid ingress, and the like.

Optionally, the plug lock includes a longitudinal cavity on the female outlet to receive a ridge of the electrical plug to secure the electrical plug, when in use. The longitudinal cavity may be in the form of a longitudinal section of a cylinder. Furthermore, a placement of the plug lock is associated with a position of the ridge on the electrical plug. In an embodiment, the plug lock comprises a plug lock socket arranged at a periphery of the female outlet. In association with the plug lock socket, the ridge of the electrical plug is inserted in the longitudinal cavity. In an instance, on engagement of the male part to the female outlet, the electrical plug can be rotated clockwise or counter clockwise to secure the electrical plug. In use, the protective plate is rotated to second position (i.e. loaded state) to engage the female outlet and the electrical plug. Meanwhile, a ridge of the electrical plug, engaged inside the plug lock socket as the electric plug is inserted, traverses an angular rotation inside the plug lock socket equal to the angular rotation of the protective plate as it rotates from the first position to the second position. Upon further insertion of the electric plug to engage the electrical contacts, the ridge descends to fit snugly in the longitudinal cavity. Optionally, the plug lock socket may comprise a plug lock cover with a hole to allow the ridge on the electrical plug to pass through. Upon passing through and turning, the ridge is then held captive by the plug lock cover to provide an additional security against the electrical plug being pulled unintentionally from the female outlet.

In a first implementation, the retractable element of the locking means is implemented as a disc arranged between the female outlet and the protective plate, wherein the protective plate includes a downwardly extending flange that encloses the disc. It will be appreciated that the disc used herein relates to a circular plate that covers the female outlet, when not in use. Furthermore, the disc is arranged inside the protective plate using a spring. Moreover, the disc cannot be rotated but is spring loaded upwards by means of the spring. An inner end of the spring is engaged with a cylindrical hub that extends downwardly from the protective plate and an outer end of the spring is engaged with a stop pin on the underside of the disc. The spring acts both as a press spring and a rotation spring. In a first position, when the female outlet holes are covered by the protective plate, the disc is pressed upwards so that first protrusions on the inside of the cylindrical protective plate engage with notches in the periphery of the disc. The rotation of the protective plate is thereby blocked. A second protrusion on the inner wall extends in a circumferential notch on the disc. The second protrusion is axially longer than the other protrusions on the inner wall, thereby allowing limited relative circumferential movement between the protective plate and the disc in the second position. When the male pins are inserted in the protective plate holes and hit the disc, the disc is pressed downwards so that the first protrusions are released from the notches. The protective plate can then be rotated to its second position, which may be up to 35 degrees provided by the circumferential notch in the disc. The male pins can then be inserted in the female holes. Notably, at least two male pins are required to press down the locking disc, to unlock the locking means. In case, if just one pin or another unauthorized tool is pressed in one hole of the top, the disc will tilt and the protective plate will still be locked. Optionally, a phone contact is provided at a centre of the locking means to communicably connect the female outlet and the electrical plug.

In a variation, the safety electrical outlet further includes fanning grooves on upper side of the protective plate for receiving dirt. Any dirt is moved radially out from the tight space between the upper side of the protective plate and the outer housing of the safety electrical outlet during the rotation of the protective plate, especially when the plug is disconnected from the female outlet and the spring rotates the plate back to the first position. The dirt is flung along the radial grooves to the periphery of the protective plate. Notably, the dirt falls down in a circumferential groove formed between the outlet housing and the female part provided with the holes.

In a specific embodiment, the downwardly extending flange is made of plastic and rim of the disc is made of a fluoropolymer, to provide a sliding bearing between the protective plate and the disc. Specifically, the fluoropolymer is Teflon®.

Throughout the present disclosure the term “locking means” used herein relates to a mechanical arrangement that secures the associated components in a fixed position. Furthermore, the locking means can switch between a locked position and an unlocked position, manually or automatically, based on configuration thereof. Notably, the locking means, when in locked state, is configured to ensure that the protective plate is in first position (specifically, covering the female outlet).

The safety electrical outlet comprises a protective plate configured to cover the female outlet in a first position, wherein the protective plate is rotated from the first position to a second position for uncovering the female outlet when released by a locking means. The term “protective plate” used herein relates to a disc-shaped member or a covering arranged on the outer surface of the female outlet to provide protection to the female outlet in order to prevent accidental damage, reduce exposure of the electrical connections to external environment and limit unintended use. Furthermore, the protective plate may include through-holes equal to and configured corresponding to the receptacles of the female outlet. The term “first position” used herein relates to initial configuration and/or arrangement of the protective plate and the female outlet. Notably, the first position refers to a configuration when the receptacles of the female outlet and the holes of the protective plate are not aligned with each other. In other words, in the first position, the receptacles of the female outlet are covered with the protective plate. It may be appreciated that the term “second position” as used herein refers to a final position and/or configuration and/or arrangement of the protective plate and the female outlet. Furthermore, the second position refers to a configuration when the receptacles of the female outlet corresponds to the holes of the protective plate. In such an instance, the receptacles can receive the male part (pins) of the electrical plug to establish an electrical connection therein.

Optionally, the spring provides an upward bias to avoid a play between protective plate and the female outlet, and a rotational bias to maintain the protective plate in the first position, and to bias the protective plate towards the first position when it is in the second position.

Optionally, the protective plate includes a plurality of through-holes corresponding to receptacles of the female outlet, wherein the plurality of through-holes aligns with the receptacles of the female outlet when the protective plate is in the second position. In an instance, the plurality of through-holes is diametrically similar to the receptacles of the female outlet. Furthermore, the plurality of through-holes aligns diametrically with the receptacles of the female outlet when the protective plate is rotated from first position to second position.

Optionally, the protective plate undergoes a rotation in range of 35 to 45 degrees between the first position and the second position. More optionally, the protective plate undergoes a rotation of 39 degrees between the first position and the second position.

Optionally, the protective plate is spring loaded to allow the protective plate to revert to the first position from the second position when the electrical plug is removed. It may be appreciated that the protective plate is configured to remain in first position when in an unloaded state to maintain a protective covering over the female outlet.

Optionally, an inner end of the spring is engaged with a cylindrical hub that extends downwardly from the protective plate and an outer end of the spring is engaged with a stop pin on the underside of the disc, thereby providing means to bias the protective plate rotationally relative to the disc.

The safety electrical outlet comprises the locking means, coupled to the protective plate, configured to maintain the protective plate in the first position when in locked state, wherein the locking means releases the protective plate upon receiving the male part of the electrical plug. Notably, the locking means is coupled to the female outlet to allow the protective plate to rotate from the first position to the second position, when the male part of the electrical plug is received by the female outlet. In an example, the female outlet may include a traditional circular coupling to disengage and engage with the electrical plug. Subsequently, the locking means is disengaged to allow the female outlet to receive the male part of the electrical plug.

The locking means comprises a retractable element maintaining the protective plate in the first position, wherein the retractable element retracts to allow the locking means to release the protective plate when pressed by the male part of the electrical plug. It may be appreciated that the term “retractable element” used herein relates to a mechanical component such as a plunger, a pin, or a link arranged in a coupling to provide reciprocation, when in use. Furthermore, the retractable element is arranged in a manner such that on actuation, the locking means can switch from the locked state to the unlocked state and vice-versa. The retractable element for locking means of a safety electrical outlet, wherein the retractable element maintains a protective plate in a first position and retracts to allow the locking means to release the protective plate when pressed by a male part of an electrical plug, wherein the retractable element is at least one of: a spring-loaded U-shaped rod, a pair of resilient fingers, a button on the female outlet.

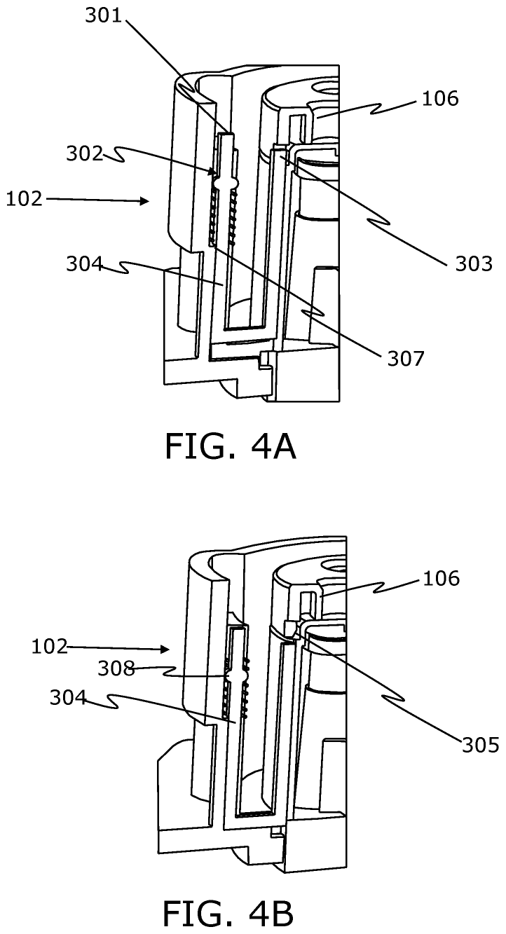

In a second implementation, the retractable element of the locking means is implemented as a spring-loaded U-shaped rod, wherein the U-shaped rod retracts when pressed by the electrical plug. In one aspect, the retractable element is configured as the spring-loaded U-shaped rod that is arranged between female outlet and an outer covering. The covering may be a hollow cylinder, or a hollow tube-shaped covering or a housing to hold the female outlet therein. Notably, the U-shaped rod includes two vertical members and a horizontal member integral to each other. In action or when in use, the spring-loaded U-shaped rod is pressed by the electrical plug to allow for the rotation of the protective covering from the first position to the second position. One such exemplary implementation of the locking means is explained in conjunction with FIGS. 4A and 4B.

In a third implementation, the retractable element of the locking means is implemented as a pair of resilient fingers that extend from the protective plate into a corresponding pair of resting slots leading into corresponding channels in the female outlet, wherein upon receiving the electrical plug, the pair of resilient fingers are biased radially outwards from the resting slots to engage with the channels thereby allowing the protective plate to rotate from the first position to second position as the resilient fingers traverse the channels. Furthermore, the “pair of resilient fingers” refers to protruding elements that may include shapes of a partial cylinder or a partial cone configured in the hole of the protective plate that is operable to receive the earth pin as the male part of the electrical plug. Moreover, the pair of resilient fingers may rest in a converging position at initial state.

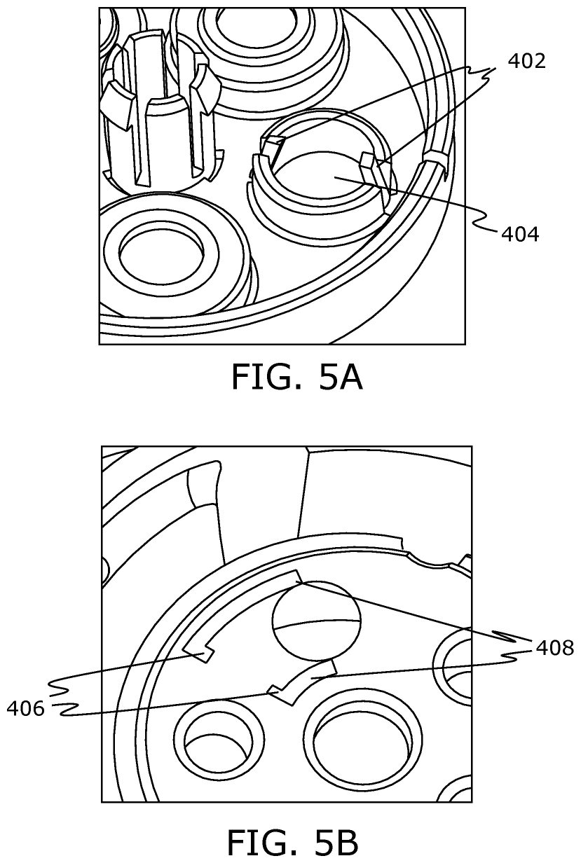

In action or in use, when the earth pin of the electrical plug is inserted into the hole of the protective plate comprising such a pair of resilient fingers, the pair of resilient fingers are diverged radially outwards from the resting slots to engage in the respective channel and the protective plate rotates from the first position to the second position. One such exemplary implementation of the locking means is explained in conjunction with FIGS. 5A and 5B.

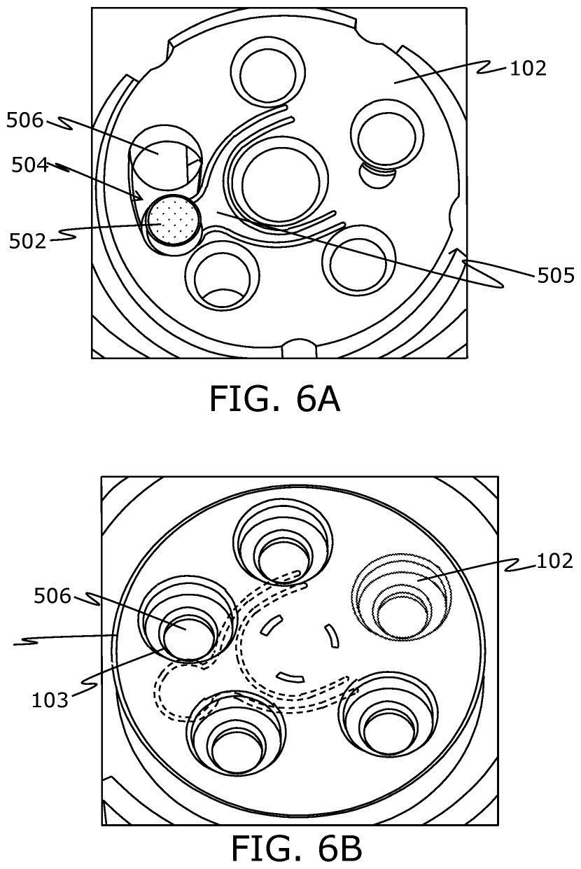

In a fourth implementation, the retractable element of the locking means is implemented as a button on the female outlet, wherein the button retracts into the female outlet when pressed by the electrical plug. The retractable element is configured as the button to engage or disengage the protective plate from the first position to the second position. Furthermore, the button is arranged aligning to a hole in the female outlet that may correspond to the male part (for example earth pin) of the electrical plug. One such exemplary implementation of the locking means is explained in conjunction with FIGS. 6A and 6B.

In any of the implementations, the following may apply.

Optionally, the length of the longitudinal cavity on the plug lock corresponds to the distance between the first and the second position of the protective plate, thereby assuring that the through-holes in the protective plate are aligned with the respective receptacle in the female outlet, when the ridge on the plug hits the end of the longitudinal cavity.

Optionally, the safety electrical outlet further comprises the data connector port arranged on the protective plate to receive a data plugin arrangement from the electrical plug, for data transfer when connected. The data connector port is arranged to communicably connect to the female outlet for data transfer when connected. Optionally, the data connector port and data plug in arrangement is a phone contact.

### DETAILED DESCRIPTION OF THE DRAWINGS

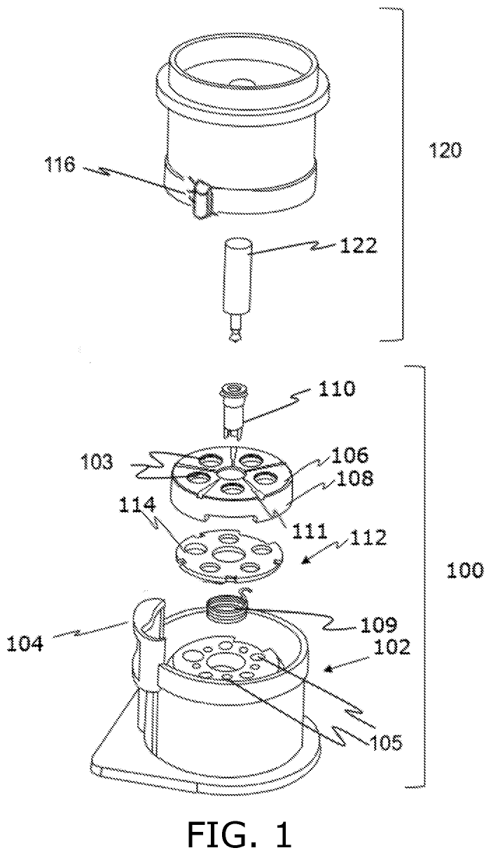

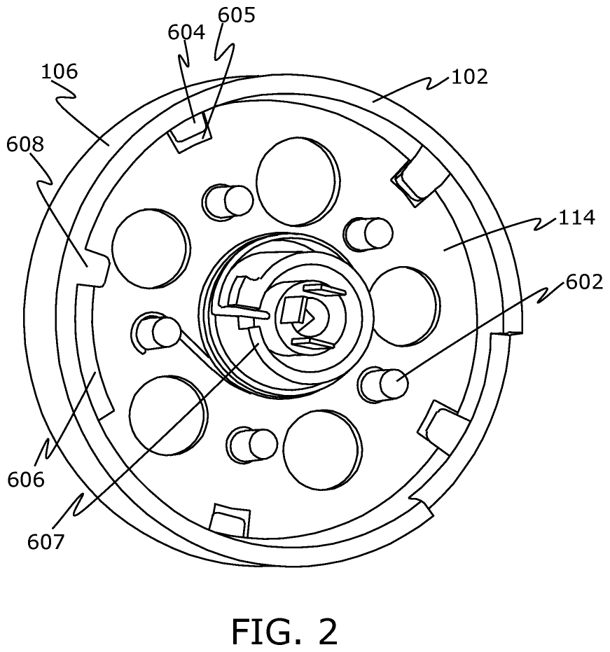

Referring to FIG. 1, illustrated is an exploded view of a safety electrical outlet 100 in accordance with the disclosure, and an electrical plug 120, with the rotation guide lateral ridge 116. The electrical plug includes a phone plug 122. The safety electrical outlet 100 includes a female outlet 102 that when in use receives a male part of an electrical plug therein to establish electrical connection therebetween. The safety electrical outlet 100 includes a plug lock socket 104 configured to secure the electrical plug to the female outlet 102, when in use. The safety electrical outlet has a locking means 112 implemented as a disc 114 in conjunction with a protective plate 106 with holes 103. The safety electrical outlet 100 includes the protective plate 106 having a downwardly extending flange 108. The disc 114 is held upwards with the help of the coil spring 109, arranged at an underside of the disc 114. A plurality of stop pins 602 (FIG. 2) are provided on the underside of the disc. They insert loosely into holes 105 in the female outlet, thereby preventing relative rotational movement between the disc and the female outlet at all times. As an alternative means (not shown) to lock the disc to the female outlet, a pin may be provided on the perimeter of the disc to engage a notch in the female outlet. Upon receiving at least two pins from the electrical plug, the disc 114 is pushed downwards and the protective plate 106 can be rotated. The protective plate 106 is shown with radially directed fanning grooves 111 in the upper surface thereof. The locking means 112 further includes a phone contact socket 110 to connect the safety electrical outlet 100 with the electrical plug. The spring 109 may be made from a memory plastic, i.e. having low creep. Such materials reduce problems of creeping current or breakdown voltage.

Referring to FIG. 2 is an underside view of the disc 114, in accordance with an embodiment of the present disclosure. The disc 114, includes the plurality of stop pins 602 arranged at an underside of the disc to allow an engagement of a tail of the spring 109 with the disc 114, which is rotationally locked to the female outlet, and to protect the spring 109 from excessive downward movement of the disc 114. The protective plate 106 has a central cylindrical hub 607 for engagement of the other tail of the spring 109. The female outlet has a recessed opening to house the central cylindrical hub 607 and spring 109. The protective plate 106 further includes plurality of protrusions 604 that engage corresponding notches 605 of the disc to lock the protective plate 106 in a locked state. The protective plate 106 includes a control pin 608 to travel inside a circumferential slot 606 in the disk 114, and thereby limits the rotation of the protective plate between the locked position and the unlocked position. A rotational allowance of 35 degrees may thereby be provided, or provided by the traverse of the ridge of the electric plug in the plug lock socket. When the pins of the electrical plug are inserted inside the protective plate 106, they push the disc 114, and thereby the notches 605 on the disc move away from the protrusions 604 on the protective plate to release the protective plate 106. Subsequently, the protective plate 106 is rotated, upon rotation of the electric plug by the user, to align the holes of the protective plate 106 and the female outlet. If the protective plate is pressed against the female outlet on just one side of the disc centre, for example by insertion of a tampering implement, the disc will tilt and at least one of the protective plate protrusions will still be locked to its notch.

When the plug is released from the female outlet, the protrusions 604 of the protective plate slide on the disc under the rotational influence of the spring 109 on the hub 607 of the protective plate until they re-enter the corresponding notches 605 on the disc to return the protective plate to its locked position.

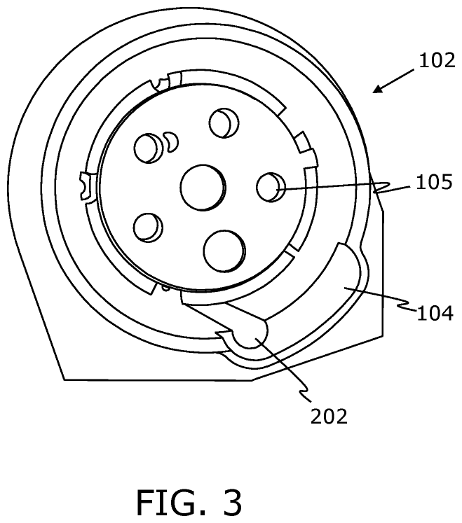

Referring to FIG. 3, illustrated is a perspective view of the female outlet 102 having the plug lock socket 104 at the outer boundary, in accordance with an embodiment of the present disclosure. The plug lock socket 104 includes a longitudinal cavity in the form of a section of a cylinder 202 on the female outlet 102 to receive a lateral ridge of the electrical plug to secure the electrical plug, when in use. Herein, when the male part of the electrical plug has been inserted into the female outlet 102, the male plug is rotated and pushed further in to secure the lateral ridge thereof in the longitudinal cavity 202 of the plug lock socket 104. A coil spring 109 is configured to bias the protective plate 106 towards the first position, so when the male part is inserted into the female outlet 102, via holes in the protective plate 106, a torque is exerted which helps to retain the lateral ridge 116 of the electrical plug in the longitudinal cavity 202.

Referring to FIGS. 3A and 3B, illustrated are sectional views of a locking means 302, in accordance with an implementation of the present disclosure. The retractable element of the locking means 302 is implemented as a spring-loaded U-shaped rod 304. The U-shaped rod 304 has a longer arm with a spring, which is retained between a circumferential ridge 308 on the longer arm and a shelf 307 on the female outlet 102. The U-shaped arm has a shorter arm 303 to interact with the protective plate 106. In FIG. 4A, there is shown the locking means in a locked state, wherein the shorter arm 303 of the U-shaped rod 304 is protruding into recess 305 maintaining the protective plate 106 in the first position. In FIG. 3B, there is shown the locking means in an unlocked state, wherein the U-shaped rod 304 is retracted to reveal, briefly, the recess 305 in the protective plate 106 by which it was locked in FIG. 4A. When the end 301 of the longer arm of the U-shaped rod 304 is pressed by the male part of the electrical plug the protective plate 106 is allowed to rotate from the first position to the second position.

Referring to FIGS. 5A and 5B, illustrated are perspective views of a locking means, in accordance with another implementation of the present disclosure. FIG. 5A illustrates a perspective view of an inverted protective plate (such as the protective plate 106 of FIG. 1), thus viewing the underneath of the protective plate. The retractable element of the locking means is implemented as a pair of resilient fingers 402 that extend downwardly inwards from diametrically opposite edges of the hole 404 in the protective plate that corresponds to the earthing receptacle of the female outlet. FIG. 4B illustrates a perspective view of the female outlet (such as the female outlet 102 of FIG. 1), wherein the female outlet comprises a pair of curved channels 408 to receive respective lower ends of the resilient fingers 402. Each curved channel has resting slot 406 directed towards the other resting slot 406 at a first end of each curved channel, the first end corresponding to the first position of the protective plate. A second end of each curved channel is positioned adjacent the earthing receptacle of the female outlet. Therefore, when in locked state, the pair of resilient fingers 402 extend from the protective plate into the resting slot 406. Upon receiving the male part of electrical plug (specifically, the earthing pin of the electrical plug), the pair of resilient fingers 402 are urged to diverge outwardly and engage in the channel 408 allowing rotation of the protective plate from the first position to the second position.

Referring to FIGS. 6A and 6B, illustrated are perspective views of a locking means, in accordance with yet another implementation of the present disclosure. FIG. 6A shows the female outlet from above, without the protective plate, which has been excluded in or to see the detail of the female outlet. FIG. 6B shows the protective plate from above, and parts of the female outlet are visible either outside the perimeter of the protective plate or through the through holes e.g. 103 of the protective plate. The retractable element of locking means is implemented as a flexible tongue 505 formed in the female outlet. In FIG. 6A, the flexible tongue 505 is “wishbone” shaped, with its legs connected to the female outlet and extending around a central orifice in the female outlet. The outer end of the tongue is shaped as a button 502 located beyond where the legs join on an extending cantilever. The button 502 is circumferentially placed between the earth pin hole 506 and one of the other female outlet holes. The tongue is pre-stressed outwards so that the button protrudes above the female outlet upper surface into the through-hole 103 of the protective plate corresponding to the earth pin, maintaining the protective plate 106 locked in the first position. A recess 504 circumferentially connects the location of the button 502 to earth pin hole 506 of the female outlet 102. When the electrical plug is inserted into the female outlet, the earth pin presses the button 502 inwards to release the protective plate 106. When rotating the protective plate (by rotation of the electrical plug) to its second position, a recess 504 in the female outlet permits movement of the earth pin from the button to the earth pin hole 506 in the female outlet. The recess 504 in the female outlet allows the earth pin to push the button down far enough to ensure it does not impede the protective plate as it rotates. In the second position the holes of the protective plate 106 align with the holes of the female outlet 102, as shown in FIG. 5B, and button 102 in hidden.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1.-14. (canceled)

15. A safety electrical outlet comprising:
a female outlet that when in use receives a male part of an electrical plug therein to establish electrical connection therebetween;
a protective plate configured to cover the female outlet in a first position, wherein the protective plate is rotated from the first position to a second position for uncovering the female outlet when released by a locking means, wherein the protective plate includes a plurality of holes corresponding to receptacles of the female outlet, wherein the plurality of holes aligns with the receptacles of the female outlet when the protective plate is in the second position; and
the locking means, coupled to the protective plate, configured to maintain the protective plate in the first position when in a locked state, wherein the locking means releases the protective plate upon receiving the male part of the electrical plug, the locking means comprising:
a retractable element maintaining the protective plate in the first position, wherein the retractable element retracts to allow the locking means to release the protective plate when pressed by the male part of the electrical plug,
wherein the retractable element is a disc, having holes arranged to communicate with the plurality of holes in the protective plate and in the female outlet,
wherein the disc is:
arranged between the female outlet and the protective plate;
rotationally locked to the female outlet;
tiltably supported on the female outlet; and
axially spring biased towards the protective plate,
wherein the protective plate is spring biased towards its first position.

16. A safety electrical outlet of claim 15, wherein one spring provides the axial bias of the disc and the rotational spring bias of the protective plate towards its first position.

17. A safety electrical outlet of claim 15, wherein an inner end of the spring is engaged with a cylindrical hub that extends downwardly from the protective plate and an outer end of the spring is engaged with a stop pin on the underside of the disc, thereby providing means to bias the protective plate rotationally relative to the disc.

18. A safety electrical outlet of claim 15, wherein the protective plate includes a downwardly extending flange that encloses the disc.

19. A safety electrical outlet of claim 15, wherein the safety electrical outlet further includes fanning grooves on outer side of the protective plate.

20. A safety electrical outlet of claim 15, wherein the downwardly extending flange is made of plastic and rim of the disc is made of a fluoropolymer, to provide a sliding bearing between the protective plate and the disc.

21. A safety electrical outlet of claim 15, wherein the spring is made of a memory plastic.

22. A safety electrical outlet comprising:
a female outlet that when in use receives a male part of an electrical plug therein to establish electrical connection therebetween;
a protective plate configured to cover the female outlet in a first position, wherein the protective plate is rotated from the first position to a second position for uncovering the female outlet when released by a locking means, wherein the protective plate includes a plurality of holes corresponding to receptacles of the female outlet, wherein the plurality of holes aligns with the receptacles of the female outlet when the protective plate is in the second position; and
the locking means, coupled to the protective plate, configured to maintain the protective plate in the first position when in a locked state, wherein the locking means releases the protective plate upon receiving the male part of the electrical plug, the locking means comprising:
a retractable element for maintaining the protective plate in a first position, wherein the retractable element retracts to allow the locking means to release the protective plate when pressed by a male part of an electrical plug, wherein the retractable element is at least one of: a spring-loaded U-shaped rod, a pair of resilient fingers, a button on the female outlet.

23. A safety electrical outlet of claim 22, wherein the retractable element of the locking means is implemented as a spring-loaded U-shaped rod, wherein the U-shaped rod retracts when pressed by the male part of the electrical plug.

24. A safety electrical outlet of claim 23, wherein the spring-loaded U-shaped rod has a longer arm with a spring and a shorter arm to interact with the protective plate,
wherein the spring is retained between a circumferential ridge on the longer arm and a shelf on a female outlet, and
wherein the spring provides an upward bias to the retractable element towards a position where the retractable element locks the protective plate to the female outlet.

25. A safety electrical outlet of claim 22, wherein the retractable element of the locking means is implemented as a pair of resilient fingers that extend from the protective plate into a corresponding pair of resting slots leading into a corresponding pair of channels in the female outlet, wherein upon receiving the male part of the electrical plug, the pair of resilient fingers are biased radially outwards from the resting slots to engage with the channels, thereby allowing the protective plate to rotate from the first position to the second position.

26. A safety electrical outlet of claim 25, wherein the pair of resilient fingers extends downwardly inwards from diametrically opposite edges of a hole in the protective plate that corresponds to the earthing receptacle of the female outlet, wherein distal ends of the pair of resilient fingers are engaged in a respective pair of curved channels in the female outlet, the curved channels having a respective pair of opposed resting slots corresponding to the position of the resilient fingers when the protective plate is in its first position.

27. A safety electrical outlet of claim 22, wherein the retractable element of the locking means is implemented as a button on the female outlet, wherein the button retracts into the female outlet when pressed by the male part of the electrical plug.

28. A safety electrical outlet of claim 27, wherein the button is included on a flexible tongue associated with the female outlet, and wherein legs of the flexible tongue are connected to the female outlet and extend around a central orifice in the female outlet.
